(19) United States
(12) Patent Application Publication
(10) Pub. No.: US 2026/0222034 A1
(43) Pub. Date: Jul. 30, 2026

(54) METHODS FOR AIML OPERATION MANAGEMENT IN WLAN

(71) Applicant: INTERDIGITAL PATENT HOLDINGS, INC., Wilmington, DE (US)

(72) Inventors: Xiaofei WANG, North Caldwell, NJ (US); Zinan Lin, Basking Ridge, NJ (US); Hanqing Lou, Syosset, NY (US); Mahmoud Saad, Montreal, CA (US); Rui Yang, Melville, NY (US); Joseph Levy, Merrick, NY (US)

(21) Appl. No.: 19/147,599

(22) PCT Filed: Jan. 12, 2024
(86) PCT No.: PCT/US2024/011423

§ 371 Date: Jul. 11, 2025

Related U.S. Application Data
(60) Provisional application No. 63/438,939, filed on Jan. 13, 2023.
(60) Provisional application No. 63/441,326, filed on Jan. 26, 2023.

(51) Int. Cl. H04B 7/06; H04L 41/16; H04W 8/22

(52) U.S. Cl. CPC H04B 7/0626; H04L 41/16; H04W 8/22

(57) ABSTRACT

Methods and devices are disclosed for enabling a wireless station (STA) to use artificial intelligence machine learning (AIML)-based procedures in a wireless network. The STA receives notification that an access point (AP) supports artificial intelligence machine learning (AIML)-based procedures and sends indication of its own AIML capabilities to the AP. The STA receives AIML instructions from the AP, and in one embodiment, the STA accesses a channel in the wireless network using AIML procedures based on the received AIML instructions. AIML-based operation management procedures may be defined and used for channel access, channel state information (CSI) feedback, uplink orthogonal frequency division multiple access (OFDMA) random access (UORA) and/or a service period (SP) specifying a duration when the STA may use AIML-based operation management procedures. Additional embodiments are disclosed.

### CROSS-REFERENCE TO RELATED APPLICATIONS

This application claims the benefit of U.S. Provisional Application No. 63/441,326, filed Jan. 26, 2023, and U.S. Provisional Application No. 63/438,939, filed Jan. 13, 2023, the contents of both are incorporated herein by reference.

### BACKGROUND

Artificial intelligence and machine learning (AIML) algorithms may be used to optimize the operations for wireless networks, for example channel access, channel state information (CSI) compression, beamforming and other processes. This may be achieved using AIML by adjusting parameters and choosing reward actions. However, in wireless local area networks (WLANs) for example, an access point (AP) managing its own basic service set (BSS) should have a certain level of controls of the AIML operations of its associated STAs. An AP may also need to manage AIML operations in its own BSS to ensure fairness of channel access among STAs that are legacy devices and STAs that are AIML capable. One issue is how to provide efficient procedures for APs and STAs for effective management of AIML-based channel access operations within a network. This and other issues may need solutions for effective utilization of AIML in wireless networking.

### SUMMARY

Various methods and devices of operating in a wireless network utilizing artificial intelligence machine learning (AIML) may include notifying wireless devices that a network access station, such as an access point, supports artificial intelligence machine learning (AIML)-based procedures capability in wireless communications using a beacon or frame including an AIML capabilities element. The AIML-enabled wireless devices identify their AIML capabilities to the network access station and receive AIML instructions and/or permitted timing information from the wireless access station, such as an access point (AP). The AIML instructions and timing information may be determined by the AP to balance service access and/or contention with legacy devices not having AIML capabilities. The AIML-enabled devices may then communicate in the wireless network using AIML procedures based on the received AIML instructions and/or permitted timing information. The AIML procedures may be related to AIML-based channel access, AIML-based channel state information (CSI) compression and sounding feedback, AIML-based beamforming and others where AIML is beneficial. The AP may also determine the AIML timing information for service periods (SPs) where AIML-based procedures may be permitted and durations where AIML-based procedures are not permitted by AIML-enabled STAs.

In one aspect, AIML-based Channel Access Operation Management Procedures of embodiments below may be provided by an access point (AP) using an AIML element having various AIML fields described herein. In one non-limiting aspect, an AIML element may include an AIML Control field, an AIML Info field, an AIML service period (SP) field, an AIML medium access control (MAC) field and an AIML uplink orthogonal frequency division multiple access (OFDMA) random access (UORA) field to control various aspects of AIML-enabled wireless devices. Further aspects detail management procedures for coordinated and AIML-based operations for multi-link devices (MLDs) and multiple-MLDs (MMLDs) among others.

In one example, a STA receives notification that an access point (AP) supports artificial intelligence machine learning (AIML)-based procedures and sends indication of its own AIML capabilities to the AP. The STA receives AIML instructions from the AP, and in one embodiment, the STA accesses a channel in the wireless network using AIML procedures based on the received AIML instructions. AIML-based operation management procedures may be defined and used for channel access, channel state information (CSI) feedback, uplink orthogonal frequency division multiple access (OFDMA) random access (UORA) and/or a service period (SP) specifying a duration when the STA may use AIML-based operation procedures. Additional embodiments are disclosed.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example format of an AIML element according to various embodiments;

FIG. 3 illustrates an example format of an AIML Control field of one embodiment;

FIG. 4 illustrates an example format of an AIML Info field of an embodiment;

FIG. 5 illustrates an example format of an AIML Operation Control field of an embodiment;

FIG. 6 is a flow diagram illustrating a general method of AIML operation between devices in a wireless network;

FIG. 7 is a flow diagram illustrating a method for a station (STA) using AIML procedures for accessing a channel according to one embodiment;

FIG. 8 is a timing chart illustrating an example embodiment of Periodic AIML based CSI Duration;

FIG. 9 is a timing chart illustrating an example embodiment of Aperiodic AIML based CSI Duration;

FIG. 10 illustrates a format of an exemplary AIML CSI Reporting Duration Element embodiment;

FIG. 11 shows an example embodiment for a Control field format in AIML based CSI Reporting Duration element;

FIG. 12 illustrates an example AIML-based CSI Duration Information field in an AIML-based CSI Reporting Duration element according to one embodiment;

FIG. 13 is an example embodiment for Notification of Individual Group of an AIML-based CSI Reporting Duration;

FIG. 14 illustrates embodiments of Notification of Multiple Groups of AIML-based CSI Reporting Durations;

FIG. 15 shows and example embodiment of an AIML-based CSI Reporting Duration Constraint Parameter element;

FIG. 16 illustrates an example embodiment for Non-AP STA initiated No AIML-based CSI report operation;

FIG. 17 illustrates an example embodiment for Non-AP STA initiated AIML-based CSI Report Duration operation;

FIG. 18 shows an example embodiment of a Negotiation Procedure to assign AIML SPs Individually; and

FIG. 19 illustrates an example embodiment for a Negotiation Procedure to assign AIML SPs to a Group of STAs.

### DETAILED DESCRIPTION

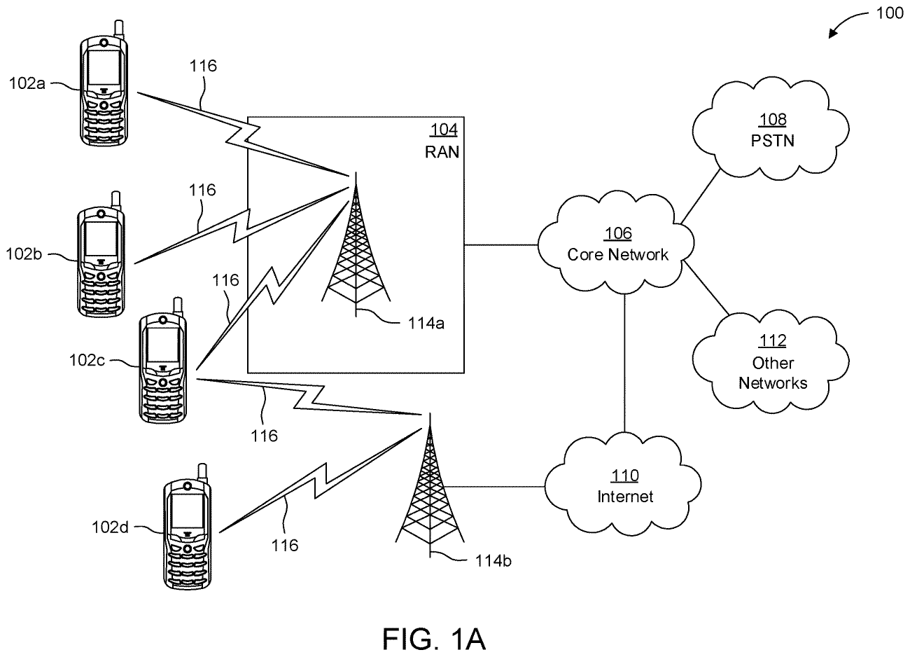

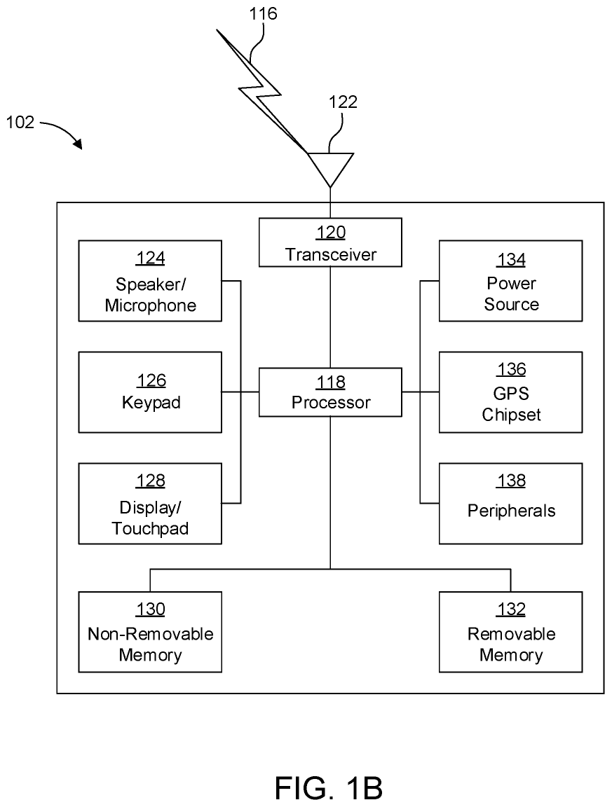

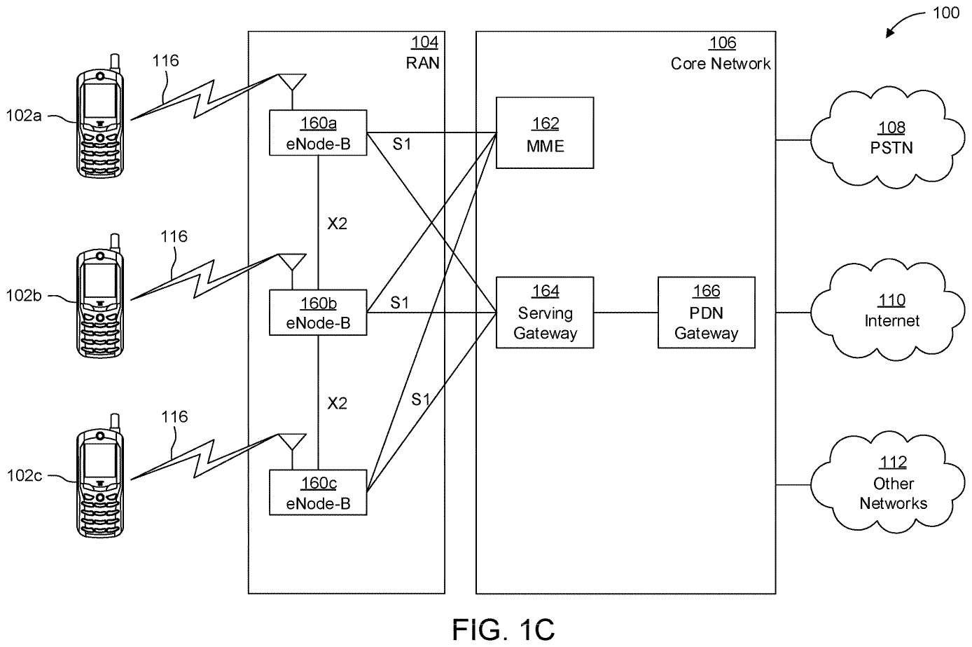

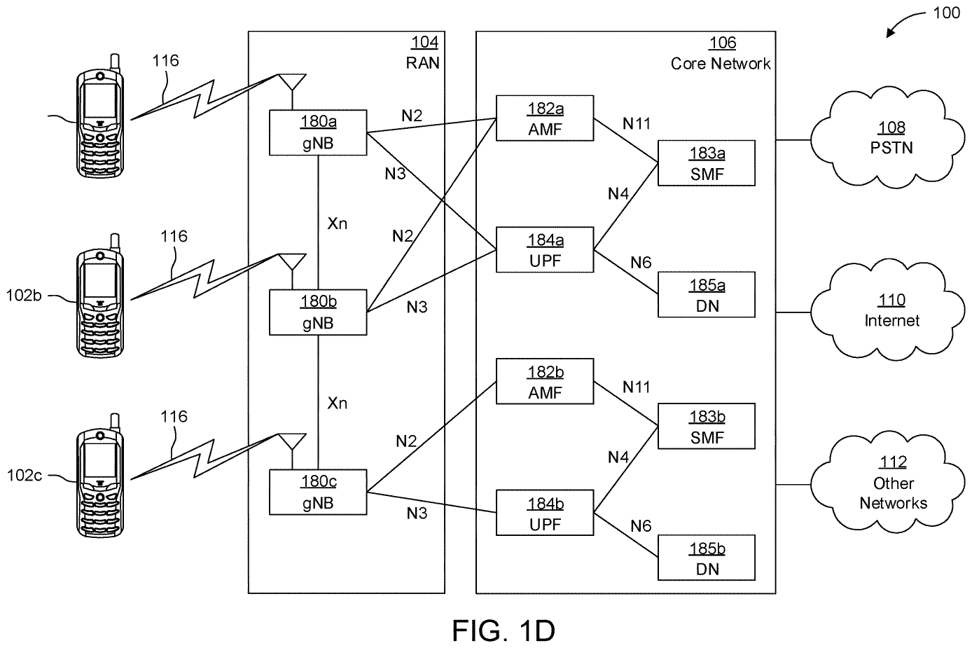

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. Itwill be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Machine Learning and Federated Learning will now be described. Machine Learning may be defined as a computer program to learn from experience (E) with respect to some class of tasks (T), and performance measure (P), if its performance at tasks in T, as measured by P, improves with experience E.

There are many different kinds of machine learning, depending on the nature of the task T the system will learn, the nature of the performance measure P used to evaluate the system, and the nature of the training signal or experience E it is given. Machine learning implementations are classified into three major categories, depending on the nature of the learning “signal” or “response” available to a learning system which are as follows:

Supervised learning: When an algorithm learns from example data and associated target responses that can consist of numeric values or string labels, such as classes or tags, in order to later predict the correct response when posed with new examples comes under the category of Supervised learning. This approach is indeed similar to human learning under the supervision of a teacher. The teacher provides good examples for the student to memorize, and the student then derives general rules from these specific examples.

Unsupervised learning: An algorithm that learns from plain examples without any associated response, leaving to the algorithm to determine the data patterns on its own. This type of algorithm tends to restructure the data into something else, such as new features that may represent a class or a new series of un-correlated values. They are quite useful in providing humans with insights into the meaning of data and new useful inputs to supervised machine learning algorithms.

Reinforcement learning: In this class of problems, the system or agent has to learn how to interact with its environment. This can be encoded by means of a policy a=πr(x), which specifies which action to take in response to each possible input x (derived from the environment state). The difference from supervised learning is that the system is not told which action is the best one to take (i.e., which output to produce for a given input). Instead, the system just receives an occasional reward (or punishment) signal in response to the actions that it takes. This is like learning with a critic, who gives an occasional thumbs up or thumbs down, as opposed to learning with a teacher, who tells you what to do at each step.

Federated Learning: Federated Learning is a machine learning setting where the goal is to train a high-quality centralized model while training data remains distributed over a large number of clients each with unreliable and relatively slow network connection. The learning algorithms considered for this setting are on each round, each client independently computes an update to the current model based on its location data, and communicates this update to a central server, where the client-side updates are aggregated to compute a new global update. The typical clients in this setting are mobile phones, and communication efficiency is of utmost importance. Federated Learning enables mobile phones to collaboratively learn a shared prediction model while keeping all the training data on device, decoupling the ability to do machine learning from the need to store the data in the cloud. The training data is kept locally on users' mobile devices, and the devices are used as nodes performing computation on their local data in order to update a global model.

A naive implementation of the Federated Learning requires that each client sends a full model (or a full model update) back to the server in each round. For large models, this step is likely to be the bottleneck of Federated Learning due to multiple factors. One factor is the asymmetric property of internet connection speeds, e.g., the uplink is typically much slower than downlink. There are many ways to reduce the uplink communication (from the client to the server) cost in Federated Learning including: Structured updates, where an update from a restricted pace can be learned and it can be parametrized using a smaller number of variables; and Sketched updates, where a full model is updated and then it may be compressed before sending to the server.

Standardization of Federated Learning: IEEE 3652.1, a new IEEE standard, provides a blueprint for data usage and model building across organizations while meeting applicable privacy, security and regulatory requirements. It defines the architectural framework and application guidelines for federated machine learning, including: 1) description and definition of federated learning; 2) the types of federated learning and the application scenarios to which each type applies; 3) performance evaluation of federated learning, and 4) associated regulatory requirements.

In this disclosure the following subjects, among others, may be addressed:
1. AIML Based Channel Access Operation Management. AIML algorithms may be used to optimize the operations in a wireless network, for example channel access by devices in a WLAN, by adjusting parameters and choosing the reward actions. However, an AP managing its own basic service set (BSS) should have certain level of controls of the AIML operations of STAs that are associated with the AP. An AP may also need to manage AIML operations in its own BSS to ensure fairness of channel access among STAs that are legacy devices and STAs that are AIML capable. One issue is how to provide efficient procedures for APs and STAs for effective management of AIML-based channel access operations within a network.
2. AIML-based channel state information (CSI) compression and sounding feedback management procedures. CSI compression is an effective tool to reduce overhead. AIML-based CSI compression and its corresponding sounding feedback procedure have been shown to provide significant performance enhancement. However, such AIML-based CSI compression and sounding feedback procedures may need to be managed due to changing circumstances (e.g., the capabilities of non-AP STAs) and the channel and traffic conditions. One issue is how to provide an effective management procedure for the AIML-based CSI compression and sounding feedback operations in varying conditions.
3. AIML Service Periods Procedure. AIML elementary operations may include Dataset Generation, Dataset Transfer, Training, Inference, Model Transfer, and Model Parameters Tuning. A STA supporting the AIML feature may need to perform one or more of these operations. It is possible that the AP may get overloaded by requests from the AIML-capable STAs due to the volume of operations that may need to be performed. Additionally, AIML-based services may include AIML-based channel access, AIML-based beam forming, AIML-based resource allocation, etc. Legacy STAs which do not support AIML capabilities may be at a disadvantage in obtaining access service period in a contention environment with AIML-enabled STAs, and fairness between AIML-capable STAs and legacy STA may become an issue. STAs supporting AIML features may need to negotiate with the AP to operate using AIML features. Accordingly, the AP may specify service periods (SPs) in which a STA can operate in the AIML mode and a procedure to negotiate the AIML SPs should be defined.
4. AIML Management Procedure for multi-link devices (MLDs) and multiple-MLDs (MMLDs). Multi-link devices (MLDs) and Multiple Multi-link devices (MMLDs) may be deployed in 802.11be networks and beyond. MLDs and MMLDs may provide a new way to coordinate operations as well AIML-based operations. Coordinating MLD/MMLD operations and AIML-based operations may also need to be managed. One issue is how to provide an efficient management procedure for MLD and MMLD-based coordination and AIML-based operations.

Embodiments disclosed herein may address one or more of the foregoing subjects as described in greater detail below. In a first embodiment for AIML-Based Channel Access Operation Management Procedure for WLAN, an advertisement procedure may be included. In one example of an AIML-based WLAN operation advertisement procedure where an AP or AP multi-link device (MLD) may advertise or indicate support for AIML-based operations in its BSS or in the BSS for one of its affiliated APs.

An AP may indicate that it supports AIML operation by setting a bit, e.g., an AIML Capable bit, in one of the Capability elements, such as HT Capability element, VHT Capability element, HE Capability element, EHT Capability element, UHR Capabilities or extended capability element, or other fields or elements. The AIML Capable bit set=1, or “Support,” may imply that the same AP may include an AIML element in frames that it transmits, such as a beacon frame, AIML Beacon frames, short beacon frames, fast initial link set-up (FILS) discovery frame, or other type of frames such as AIML announcement frames.

In another example, an AP may indicate that it supports AIML operation by including an AIML element in the frames that it transmits, such as beacon frame, AIML Beacon frames, short beacon frames, FILS discovery frame, or other type of frames such as AIML announcement frames. In yet another example, an AP may indicate that it supports AIML operation by transmitting AIML related frames such as AIML announcement frames or AIML beacons.

An AP that is affiliated with an AP MLD may indicate that it or the AP MLD supports AIML operation by setting a bit, e.g., the AIML Capable bit, in one of the Capability elements, such as HT Capability element, VHT Capability element, HE Capability element, EHT Capability element, UHR Capabilities element or extended capability element. The AIML Capable bit set=1, or “Support,” may imply that the same AP or other APs affiliated with the AP MLD may include an AIML Element in frames that it transmits, such as beacon frame, AIML Beacon frames, short beacon frames, FILS discovery frame, or other type of frames such as AIML announcement frames. In another example, an AP that is affiliated with an AP MLD may indicate that it or the AP MLD supports AIML operation by including an AIML Element in frames that it transmits, such as beacon frame, AIML Beacon frames, short beacon frames, FILS discovery frame, or other type of frames such as AIML announcement frames. In yet another example, an AP that is affiliated with an AP MLD may indicate that it or the AP MLD supports AIML operation by transmitting AIML related frames such as AIML announcement frames or AIML beacons.

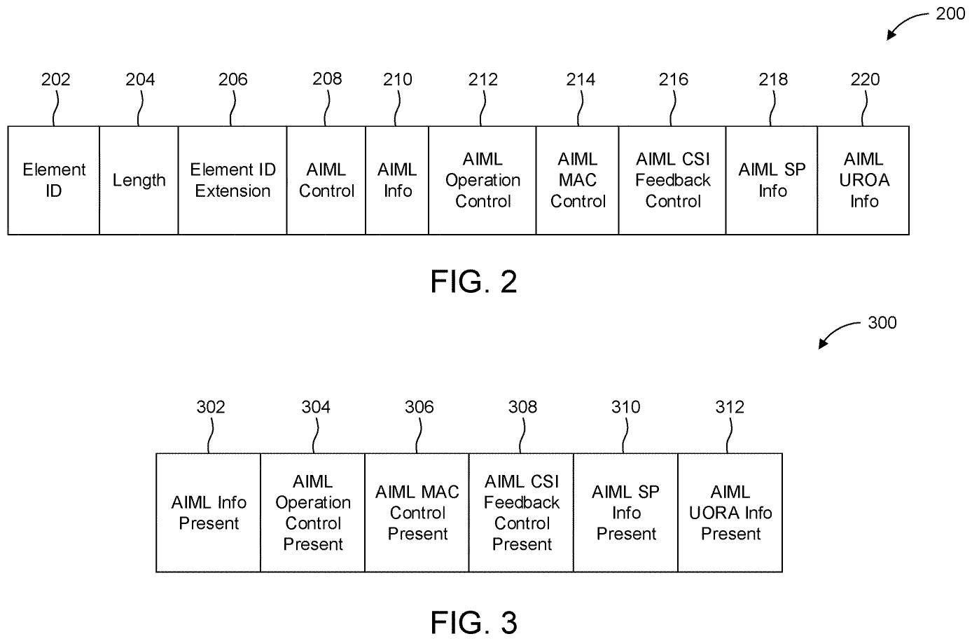

Referring to FIG. 2, an AIML element 200 according to certain embodiments may have the example format shown. The AIML element 200 may contain one or more of the following fields: (1) Element ID field 202 and an Element ID Extension field 206, where one or the combination of the Element ID field 202 and/or the Element ID extension field 206 may indicate that the current element is an AIML element 200; (2) Length field 204, which indicates the length of the AIML element 200; (3) AIML Control field 208, which may indicate the presence of one or more additional fields in the AIML element 200, for example, AIML Info field 210, AIML Operation Control field 212, AIML MAC Control field 214, AIML CSI Feedback Control field 216, AIML service period (SP) Info field 218, and/or AIML uplink OFDM-based random access (UORA) Info field 220.

In the example embodiment of FIG. 3, an example design of the AIML Control field 300 is shown. AIML Control field 300 may include an AIML Info Present field/subfield 302. In one example, if the AIML Info Present field 302 is set=1, it may indicate that the AIML Info field (e.g., 210 of FIG. 2) may be present in the AIML element (e.g., 200 of FIG. 2); otherwise the field is not present. AIML Control field 300 may further include an AIML Operation Control Present field 304. In one example, if AIML Operation Control Present field 304 is set=1, it may indicate that the AIML Operation Control field (e.g., 212 of FIG. 2) may be present in the AIML element (e.g., 200 of FIG. 2); otherwise the field is not present. AIML Control field 300 may further include an AIML CSI Feedback Control Present field 308. If AIML CSI Feedback Control Present field 308 is set=1, it may indicate that the AIML CSI Feedback Control field (e.g., 216 of FIG. 2) may be present in the AIML element (e.g., 200 of FIG. 2); otherwise the field is not present. AIML Control field 300 may further include an AIML SP Info Present field 310. If AIML SP Info Present field 310 is set=1, it may indicate that the AIML SP Info field (e.g., 218 of FIG. 2) may be present in the AIML element (e.g., 200 of FIG. 2); otherwise the field is not present. AIML Control field 300 may further include an AIML Uplink OFDMA Random Access (UORA) Info Present field 312 and if set=1, it may indicate that the AIML UORA Info field (e.g. 220 of FIG. 2) may be present in the AIML element (e.g., 200 of FIG. 2); otherwise the field is not present.

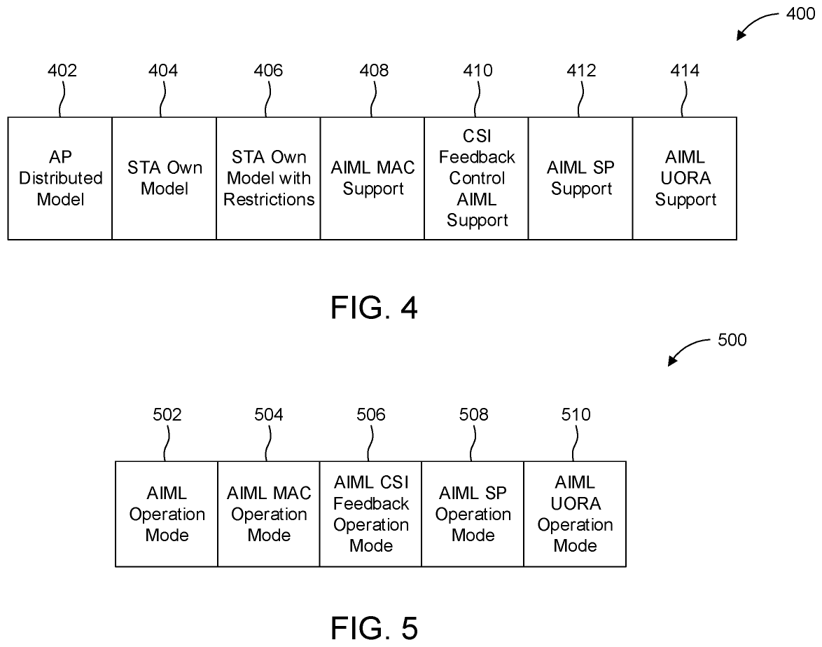

Referring to FIG. 4, an example AIML Info field 400 is shown. AIML Info field 400 may be used to indicate the information related to AIML operations that are supported by the AP or the AP MLD with which the AP is affiliated. In the example of FIG. 4, AIML Info field 400 may include an AP Distributed Model subfield 402. For example, the AP Distributed Model subfield 402 may indicate whether the transmitting AP is providing AIML models that can be used in AIML operations. AIML Info field 400 may also indicate subfields for each AIML operation, such as AIML medium access control support field 408, CSI feedback control AIML support subfield 410, AIML SP support subfield 412 and/or AIML UORA support subfield 414, whether the AP provides AIML models to STAs or non-AP MLDs. In another example, the AIML Info field 400 may also indicate the details on one or more AIML models that are distributed by the AP or AP MLD, e.g., for all AIML operations or one particular AIML operation.

The STA Own Model subfield, or field 404, shown in FIG. 4 indicates whether the AP or AP MLD supports the AIML operations in which a STA or non-AP MLD may use its own AIML models. This subfield may also indicate for each AIML operation, such as medium access, CSI feedback, AIML SP and AIML UORA whether the STA or non-AP MLD is allowed to use its own models. In another example, STA Own Model field 404 may also indicate the details on one or more AIML models or one or more classes of AIML models that a STA or non-AP MLD is allowed to use, e.g., for all AIML operations or one particular AIML operation.

The STA Own Model with Restriction field 406 of FIG. 4 indicates whether the AP or AP MLD supports the AIML operations in operations in which a STA or non-AP MLD may use its own AIML models, but with one or more restrictions. The restrictions may be indicated in field 406 or in one or more fields that provide information regarding a particular AIML operation, such as medium access, CSI feedback, AIML SP or AIML UORA. STA Own Model with Restriction field 406 may also indicate for each AIML operation, such as medium access, CSI feedback, AIML SP and AIML UORA, whether the STA or non-AP MLD is allowed to use its own models with restrictions. In another example, field 406 may also indicate the details on one or more AIML models or one or more classes of AIML models that a STA or non-AP MLD is allowed to use, e.g., for all AIML operations or one particular AIML operation, with restrictions.

The AIML MAC Support field 408 of FIG. 4 indicates whether the AP or AP MLD supports medium access procedures. This field may include restrictions on AIML MAC operations, such as minimum wait time, whether AIML MAC models must obey network allocation vectors (NAVs), etc.

The CSI Feedback Control AIML Support field of AIML Info field/element 410 shown in FIG. 4, indicates whether the AIML-based CSI Feedback procedure is supported by the AP or AP MLD. This field may also include restrictions on AIML-based CSI feedback procedure, such as minimum number of feedback clusters/indices, minimum samples required, etc.

The AIML SP Support field 412 shown in FIG. 4 indicates whether the AP or AP MLD supports service periods that are specifically used for AIML-based operations. Additional information may be included in this field regarding AIML SP such as whether broadcast target wake time (TVWT) or other type of TVWTs may be negotiated or announced for AIML-based operations.

The AIML UORA Support field 414 of FIG. 4 may indicate whether the AP or AP MLD supports AIML-based UORA operations. This field may also include restrictions or information related to the AIML-based UORA operations, such as minimum OFDMA contention window (OCW) values, etc.

Referring to FIG. 5, an example AIML Operation Control field 500 is shown. The AIML Operation Control field 500 may be used to indicate the status of all AIML-based operations or one or more particular AIML-based operations. An example format of AIML Operation Control field 500 may contain one or more of an AIML Operation Mode subfield 502, AIML MAC Operation Mode subfield 504, AIML CSI Feedback Operation Mode subfield 506, AIML SP Operation Mode subfield 508 and/or UORA Operation Mode subfield 510.

The AIML Operation Mode subfield 502 may indicate the operation status for all AIML-based operations and, in certain embodiments, may have one of following values:

Disabled: this value may indicate that all AIML-based operations are disabled and all STAs or non-AP MLD may only be allowed to use non-AIML-based operations. Paused: this value may indicate that all AIML-based operations are paused and all STAs or non-AP MLDs may switch to non-AIML-based operations. The STA or non-AP MLD may maintain their AIML models or continue to refine their AIML models. Enabled: this value may indicate that AIML-based operations are enabled and STAs or non-AP MLDs may be allowed to use AIML-based operations. The STAs or non-AP MLDs may be allowed to use their own AIML models with or without restrictions or use AIML models distributed by the AP or AP MLD. Enabled with registration: this value may indicate that AIML-based operations are enabled only for STAs or non-AP MLDs that have requested or registered with the AP or AP MLD that they intent to use AIML-based operations and the AP or AP MLD has acknowledged or approved the request or registration. Enabled and AP Distributed Model only: this value may indicate that AIML-based operations are enabled and STAs or non-AP MLDs may be allowed to use AIML-based operations but may be only allowed to use the AIML model(s) distributed by the AP or AP MLD. Enabled and AP Distributed Model or STA Own Model: this value may indicate that AIML-based operations are enabled and STAs or non-AP MLDs may be allowed to use AIML-based operations. The STAs or non-AP MLDs may be allowed to use the AIML model(s) distributed by the AP or AP MLD or use their own AIML models. Enabled and AP Distributed Model or STA Own Model with restrictions: this value may indicate that AIML-based operations are enabled and STAs or non-AP MLDs may be allowed to use AIML-based operations but may use the AIML model(s) distributed by the AP or AP MLD or use their own AIML models subject to restrictions indicated by the AP or AP MLD. The AIML Operation Control Mode subfield 500 may be implemented using one subfield or multiple subfields or combinations of bitmaps or subfields to indicate one or more values or combinations thereof as indicated above.

The example AIML Operation Control field 500 of FIG. 5 may further include an AIML MAC Operation Mode field 504 that may be used to indicate the AIML-based medium access operation status and may have one or more of the following values: Disabled: this value may indicate that AIML-based medium access operations are disabled and all STAs or non-AP MLD may only be allowed to use non-AIML-based medium access operations. Paused: this value may indicate that AIML-based medium access operations are paused and all STAs or non-AP MLDs may switch to non-AIML-based medium access operations. The STA or non-AP MLD may maintain their AIML models or continue to refine their AIML models. Enabled: this value may indicate that AIML-based medium access operations are enabled and STAs or non-AP MLDs may be allowed to use AIML-based medium access operations. The STAs or non-AP MLDs may be allowed to use their own AIML medium access models with or without restrictions or use AIML models distributed by the AP or AP MLD. Enabled with registration: this value may indicate that AIML-based medium access operations are enabled only for STAs or non-AP MLDs that have requested or registered with the AP or AP MLD that they intent to use AIML-based medium access operations and the AP or AP MLD has acknowledged or approved the request or registration. Enabled and AP Distributed Model only: this value may indicate that AIML-based medium access operations are enabled and STAs or non-AP MLDs may be allowed to use AIML-based medium access operations but may be only allowed to use the AIML model(s) distributed by the AP or AP MLD. Enabled and AP Distributed Model or STA Own Model: this value may indicate that AIML-based medium access operations are enabled and STAs or non-AP MLDs may be allowed to use AIML-based medium access operations. The STAs or non-AP MLDs may be allowed to use the AIML model(s) distributed by the AP or AP MLD or use their own AIML models. Enabled and AP Distributed Model or STA Own Model with restrictions: this value may indicate that AIML-based medium access operations are enabled and STAs or non-AP MLDs may be allowed to use AIML-based medium access operations but may use the AIML model(s) distributed by the AP or AP MLD or use their own AIML models subject to restrictions indicated by the AP or AP MLD. As with the previous field, this subfield 504 may be implemented using one subfield or multiple subfields or combinations of bitmaps or subfields to indicate one or more values or combinations thereof as indicated above.

The example AIML Operation Control field 500 of FIG. 5 may further include an AIML CSI Feedback Operation Mode subfield 506 that may be used to indicate the AIML-based CSI Feedback operation status. In some embodiments, AIML-based CSI Feedback Operation Mode field 506 may have one of following values: Disabled: this value may indicate that AIML-based CSI Feedback operations are disabled and all STAs or non-AP MLD may only be allowed to use non-AIML-based CSI Feedback operations. Paused: this value may indicate that AIML-based CSI Feedback operations are paused and all STAs or non-AP MLDs may switch to non-AIML-based CSI Feedback operations. The STA or non-AP MLD may maintain their AIML models or continue to refine their AIML models. Enabled: this value may indicate that AIML-based CSI Feedback operations are enabled and STAs or non-AP MLDs may be allowed to use AIML-based CSI Feedback operations. The STAs or non-AP MLDs may be allowed to use their own AIML CSI Feedback models with or without restrictions or use of AIML models distributed by the AP or AP MLD. Enabled with registration: this value may indicate that AIML-based CSI Feedback operations are enabled only for STAs or non-AP MLDs that have requested or registered with the AP or AP MLD that they intent to use AIML-based CSI Feedback operations and the AP or AP MLD has acknowledged or approved the request or registration. Enabled and AP Distributed Model only: this value may indicate that AIML-based CSI Feedback operations are enabled and STAs or non-AP MLDs may be allowed to use AIML-based CSI Feedback operations but may be only allowed to use the AIML model(s) distributed by the AP or AP MLD. Enabled and AP Distributed Model or STA Own Model: this value may indicate that AIML-based CSI Feedback operations are enabled and STAs or non-AP MLDs may be allowed to use AIML-based CSI Feedback operations. The STAs or non-AP MLDs may be allowed to use the AIML model(s) distributed by the AP or AP MLD or use their own AIML models. Enabled and AP Distributed Model or STA Own Model with restrictions: this value may indicate that AIML-based CSI Feedback operations are enabled and STAs or non-AP MLDs may be allowed to use AIML-based CSI Feedback operations but may use the AIML model(s) distributed by the AP or AP MLD or use their own AIML models subject to restrictions indicated by the AP or AP MLD. AIML CSI Feedback Operation Mode subfield 506 may also be implemented using one subfield or multiple subfields or combinations of bitmaps or subfields to indicate one or more values or combinations thereof as indicated above.

The AIML Operation Control field 500 of FIG. 5 may further include an AIML SP Operation Mode field 508 to indicate the AIML SP operation status and may have one of following values: Disabled: this value may indicate that AIML SP operations are disabled and STA or non-AP MLD may discard their AIML SP parameters if any. Paused: this value may indicate that AIML SP operations are paused and all STAs or non-AP MLDs may maintain their current SP parameters. Enabled: this value may indicate that AIML SP operations are enabled. Enabled with registration: this value may indicate that AIML SP operations are enabled only for STAs or non-AP MLDs that have requested or registered with the AP or AP MLD that they intent to use AIML SPs and the AP or AP MLD has acknowledged or approved the request or registration.

In certain embodiments, AIML Operation Control field of FIG. 5 may further include an AIML UORA Operation Mode field 510 to indicate applicable AIML-based UORA operation status. In various examples, AIML-based UORA Operation Mode field 510 may have one of following values: Disabled: this value may indicate that AIML-based UORA operations are disabled and all STAs or non-AP MLD may only be allowed to use non-AIML-based UORA operations. STAs and non-AP may discard their AIML models. Paused: this value may indicate that AIML-based UORA operations are paused and all STAs or non-AP MLDs may switch to non-AIML-based UORA operations. The STA or non-AP MLD may maintain their AIML models or continue to refine their AIML models. Enabled: this value may indicate that AIML-based UORA operations are enabled and STAs or non-AP MLDs may be allowed to use AIML-based UORA operations. The STAs or non-AP MLDs may be allowed to use their own AIML UORA models with or without restrictions or use AIML models distributed by the AP or AP MLD. Enabled with registration: this value may indicate that AIML-based UORA operations are enabled only for STAs or non-AP MLDs that have requested or registered with the AP or AP MLD that they intent to use AIML-based UORA operations and the AP or AP MLD has acknowledged or approved the request or registration. Enabled and AP Distributed Model only: this value may indicate that AIML-based UORA operations are enabled and STAs or non-AP MLDs may be allowed to use AIML-based UORA operations but may be only allowed to use the AIML model(s) distributed by the AP or AP MLD. Enabled and AP Distributed Model or STA Own Model: this value may indicate that AIML-based UORA operations are enabled and STAs or non-AP MLDs may be allowed to use AIML-based UORA operations. The STAs or non-AP MLDs may be allowed to use the AIML model(s) distributed by the AP or AP MLD or use their own AIML models. Enabled and AP Distributed Model or STA Own Model with restrictions: this value may indicate that AIML-based CSI Feedback operations are enabled and STAs or non-AP MLDs may be allowed to use AIML-based UORA operations but may use the AIML model(s) distributed by the AP or AP MLD or use their own AIML models subject to restrictions indicated by the AP or AP MLD. As with any of the previous fields/subfields, AIML UORA Operation Mode field 510 may be implemented using one subfield or multiple subfields or combinations of bitmaps or subfields to indicate one or more values or combinations thereof as indicated above.

The AIML MAC Operation Mode field 504 of the AIML Operation Control field 500 of FIG. 5, may include information needed to control the AIML-based medium access operation, such as minimum wait time, mandatory to conduct channel sensing, mandatory to obey NAV, etc. The AIML CSI Feedback Operation Mode field 506 may include information needed to control the AIML-based medium access operation, such as minimum number of feedback indices. The AIML SP Operation Mode field 508 may include the information of AIML Service Periods such as starting offset, starting Beacon Interval, frequency, duration, etc. The AIML UORA Operation Mode field 510 may include information needed to control the AIML-based UORA operations, such as minimum OFDMA contention window (OCW) values, frequency of attempts per trigger frame, etc. In the present embodiments, any field, subfield or part of the AIML element or combination thereof may be constructed using existing or new elements or fields, subfields, or other type of parts of a data, control, management frames, action frames or action frames without ACK, or PHY and MAC headers.

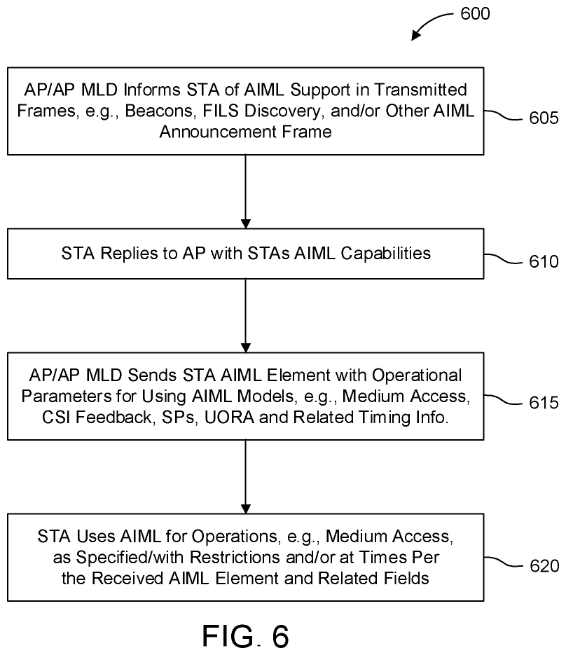

Turning to FIG. 6, an example method 600 of communicating in a wireless network using AIML operations is shown. Initially, an access point (AP) or AP multi-link device (MLD), herein after collectively referred to an AP, may inform 605 STAs that it supports AIML operations. As mentioned previously, the AP may announce AIML support in any frame it transmits such as a beacon, short beacon, AIML beacon, probe response frame, AIML announcement frame or other type of AIML specific frames to indicate that it supports AIML operations. Method 600 may continue with one or more STAs replying 610 to the AP with the STA's own AIML capabilities, which may be performed using an existing or new capabilities elements or response, such replying with a AIML element of the type previously discussed. Next, the AP sends 615 an AIML with operational parameters for using AIML models, e.g., medium access, CSI feedback, SPs, UORA and/or related timing information. At 620, the STA uses AIML for operations as specified by, or for the operational parameters specified by the received AIML element and related fields. It is noted that the order of steps shown and described in reference to FIG. 6 is not limited, and steps may be alternatively performed in different order.

In one example method for AIML discovery and operation according to certain embodiments, an AP or an AP affiliated with an AP MLD, may include an AIML element, e.g., of the type previously discussed, in any frames it transmits such as beacon, short beacon, AIML beacon, probe response frames, or AIML announcement frame. Alternatively, or in addition, the AP may transmit AIML beacons or an AIML announcement frame or other type of AIML specific frames to indicate that it, or the AP MLD, supports AIML operations.

A STA, or a STA affiliated with a non-AP MLD, may include an AIML element in any frames it transmits to an AP such as probe request, association request, AIML request frames to indicate that it or the non-AP MLD supports AIML operations. In certain embodiments, the AP or AP affiliated with an AP MLD may indicate the exact operation mode for the AIML based operations it, or the AP MLD, supports such as AIML operations, AIML-based medium access operations, AIML-based CSI Feedback operations, or AIML-based UORA operations. The AP may also indicate whether only an AP distributed AIML model is allowed to be used, or STAs or non-AP MLDs may use their own models, with or without restrictions, for example, for all AIML-based operations or for one or more of the AIML-based operations, such as AIML-based medium access, CSI feedback, AIML SP or UORA operations. The AP may also indicate whether a STA or an non-AP MLD must register or request with the AP to be able to start AIML-based operations.

An AP affiliated with an AP MLD may include an AIML element in a reported STA profile for another AP affiliated with the same AP MLD, for example, in a multi-link element, for example the basic multi-link element or AIML multi-link element. An AP may include indication of a neighbor AP is capable of supporting one or more AIML-based operations in the Reduced Neighbor report.

A STA, or non-AP STA, may follow the directions of the AP to request or start AIML-based operations that the AP or AP MLD supports. It may request the AIML models from the AP, or use its own model, with or without restrictions as indicted by the AP or AP MLD.

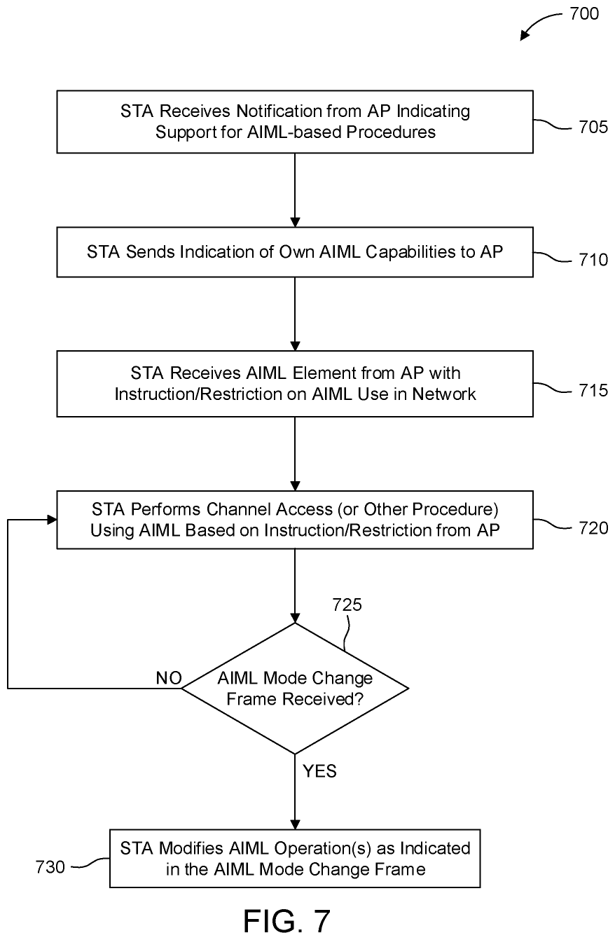

Referring to FIG. 7, a method 700 for use by a STA or non-AP MLD, generically referred to herein as STA, capable of AIML is shown. Similar to previously discussed, the STA receives 705 notification that an AP supports artificial intelligence machine learning (AIML)-based procedures in wireless communications. Next, the STA may send 710 an indication of its AIML capabilities to the AP. This indication may be provided by the STA in any of the manners discussed herein, such as by sending an AIML element to the AP, although the embodiments are not limited in this respect. Next, the STA receives 715 an AIML element from the AP defining instructions for AIML use by the STA, e.g., AIML-based channel/wireless medium access, CSI feedback, SP or UORA operations and/or to use the various AIML model types and/or with AIML restrictions as discussed in the various embodiments herein. Lastly, the STA utilizes 720 AIML operations as specified and/or within the restrictions set by the AIML element received 715 from the AP. The order of steps shown and described is not limiting and steps may be performed in different order.

In some embodiments, an AP, or an AP affiliated with an AP MLD, may disassociate a STA or non-AP MLD using the reason code “Non-compliant AIML Operations” if, e.g., it discovers that a STA or a non-AP MLD is conducting AIML operations not following the stipulations and directions of the AP or AP MLD. An AP, or an AP affiliated with an AP MLD, may transmit a frame with an AIML element, or any part of the AIML element, to change the mode of AIML-based operation. In method 700 of FIG. 7, if the WTRU receives 725 an AIML Operation Mode Change frame, the STA will modify 730 AIML operations as indicated in the received frame. For example, the AP or AP affiliated with an AP MLD may disable or pause or enable all or one or more AIML-based operations of the WTRU. It may change the AIML operation mode, for example, to only allow AP Distributed AIML models, or allow STA Own Model with restrictions, or change any of the restrictions parameters for all or one or more of AIML operations. Such a frame may be referred to as an AIML Operation Mode Change frame. Any such of changes in AIML operations may be characterized as a critical update and may be reported in any multi-link element by another AP affiliated with the same AP MLD.

A STA, or a STA affiliated with a non-AP MLD, may change its AIML-based operation if it has received 725 an AIML Operation Mode Change frame, for example, using an AIML element of the type previously discussed. The AIML Operation Mode Change indication may stop all or one or more AIML-based operations according to the received AIML operation mode change announcement, and the STA may discard its AIML models. In one example, the STA may pause all or one or more AIML-based operations according to the received AIML operation mode change announcement, but may maintain and keep refining its AIML models. The STA may enable all or one or more AIML-based operations according to the received AIML operation mode change announcement. In one example, the STA may request an AIML model from the AP or AP affiliated with the AP MLD and/or may adapt the restrictions for all or one or more AIML-based operations announced by the AP or AP affiliated with the AP MLD.

According to one embodiment of an example AIML-based UORA Channel Access Operation Management Procedure, a STA may set parameter dot11OFDMARandomAccessAIMLImplemented to true if it supports AIML-based UL OFDMA random access (AIML UORA). A STA with dot11OFDMARandomAccessAIMLImplemented set to true may indicate it may support AIML UORA in the capabilities element or other type of element, field, or frame. For example, it may set the AIML OFDMA RA Support subfield in the MAC Capabilities Information field in the Capabilities element to=1. Otherwise, it may set the AIML OFDMA RA Support subfield=0.

A non-AP STA that does not support AIML UORA may contend for the wireless medium using enhanced distributed channel access (EDCA) for sending UL frames to the AP with which it intends to communicate. In the alternative, the STA may contend for the wireless medium using traditional UORA if it supports UORA. A STA which supports AIML UORA may utilize the following rules (i)-(iv) to perform AIML UORA.
(i) Non-AP STAs may report real-time UORA transmission statistics to the AP: For example, a non-AP STA may report in the past fixed duration, UORA transmission failure rate, etc. The report may be carried in a management frame, an action frame, a control frame, a data frame, aggregated with a data/control/management frame or the compressed version of the report may be carried in the MAC header (e.g., A-Control field). In one method, the report may carry UORA transmission statistics: for example the UORA transmission failure rate in the past T microsecond (or other unit), or total UORA transmission failure numbers and total UORA transmission numbers in the past T microsecond. In one method, the report may carry subchannel-based UORA transmission statistics and the statistics may be per subchannel-based (e.g., the subchannel may be a 20 MHz subchannel, 40 MHz subchannel, etc.). In some embodiments, the report may carry more than one subchannel-based UORA transmission statistics. Example Subchannel based UORA transmission statistics may be the UORA transmission failure rate in the past T microsecond (or other unit) in a subchannel or total UORA transmission failure numbers and total UORA transmission numbers in the past T microsecond in a subchannel.
(ii) Based on the report from the non-AP STAs, and AP's recorded statistics of the usage of the assigned RA-RUs, the AP may run an AIML-based algorithm, in its local device or cloud, to determine the best UORA parameters for the BSS. Alternatively, the AP may determine a set of UORA parameters for the BSS, where each set may be used for a subchannel.
(iii) The AP may set EOCWmin and EOCWmax values using AIML-based algorithms in a new or modified UORA Parameter Set element in Management frames that it transmits.

In one method the AP may include a newly defined Subchannel-based UORA Parameter Set element in Management frames that it transmits. The Subchannel-based UORA Parameter Set element may use the example format shown in Table 1 below, or a similar element. Note this newly defined element may be used for general UORA access which provides subchannel-based UORA control.

TABLE 1
Subchannel-based UORA Parameter Set element format

| | | | |
|---|---|---|---|
| Element ID | Length | Element ID | Subchannel based |
| | | Extension | OCW Range |

The Subchannel-based OCW Range field may carry N number of OCW Range subfields for each subchannel as shown in Table 2 below.

TABLE 2
Subchannel-based OCW Range field format

| | | |
|---|---|---|
| OCW Range for | . . . | OCW Range for |
| subchannel 1 | | subchannel N |

According to one example embodiment, the value N is fixed and determined by N=maximum bandwidth/subchannel bandwidth. For example, if the maximum bandwidth supported is 320 MHz, and subchannel bandwidth is defined as 20 MHz, then N=16. Each OCW Range for subchannel n subfield may have the format shown in Table 3 below, where the EOCWmin value and EOCWmax value are the same as defined in 802.11ax.

TABLE 3
OCW Range for subchannel n subfield format

| | | |
|---|---|---|
| Per subchannel | Per subchannel | Reserved |
| EOCWmin | EOCWmax | |

In one embodiment, to prioritize low latency traffic access, the AP may include a newly defined Latency-Based UORA Parameter Set element in Management frames that it transmits. The Latency-Based UORA Parameter Set element may use the example format shown in Table 4 below. Note that this newly defined element may be used for general UORA access which provides latency-based UORA control.

TABLE 4
Latency-based UORA Parameter Set element format

| | | | |
|---|---|---|---|
| Element ID | Length | Element ID | Latency/AC/TID |
| | | Extension | based OCW Range |

The Latency Based OCW Range field may carry N number of OCW Range subfields for each access channel (AC)/traffic identifier (TID)/Latency category as shown in Table 5 below.

TABLE 5
Latency-based OCW Range field format

| | | |
|---|---|---|
| OCW Range for | . . . | OCW Range for |
| Latency/AC/TID 1 | | Latency/AC/TID N |

In one method, the value N may be fixed and determined by the number of supported ACs/TIDs/Latency categories. For example, if AC is used, N=4; if TID is used N=8 or 16, etc. Each OCW Range for AC/TID/Latency category n subfield has format shown in Table 6. The EOCWmin value and EOCWmax value are the same as defined in 802.11ax.

TABLE 6
OCW Range for Latency/AC/TID n subfield format

| | | |
|---|---|---|
| Per | Per subchannel | Reserved |
| Latency/AC/TID | EOCWmax | |
| EOCWmin | | |

In another embodiment, the transmission and retransmission procedures of the AIML UORA may be modified from the conventional UORA procedures. The AP may include necessary information for AIML UORA in a newly defined AIML-based UORA Parameter Set element in Management frames that the AP transmits. For example, there may be several predefined modes to adjust OCW value(s) after successful and unsuccessful UORA transmissions. In one example embodiment, there may be a AIML UORA Mode Indication field/subfield defined in the AIML-based UORA Parameter Set element.
(iv) The AP may indicate the range or selection of OFDMA contention window (OCW) in the Trigger frame which triggers the AIML UORA transmissions. In one embodiment, an AIML UORA Trigger frame type may be defined and signaled, e.g., through a Trigger Type subfield in the Common Info field in a Trigger frame.

According to various embodiments, a basic Trigger frame may be utilized for AIML UORA transmissions. In this way AIML UORA information may be carried in the User Info field of the AIML UORA Trigger frame or Trigger Dependent User Info subfield in the User Info field of the AIML UORA Trigger frame.

In certain embodiments, one or more special association ID (AID) values may be used to indicate AIML UORA triggers. In this way AIML UORA information may be carried in the Trigger Dependent User Info subfield in the User Info field of the basic Trigger frame. Non-AP STAs which identified the AIML UORA trigger frame may obtain the AIML UORA information accordingly.

Certain example embodiments may use a Trigger frame which triggers AIML UORA transmission and may carry information including for example: (1) Next OCW assignment: the AP may indicate a value which may be used by a non-AP STA to derive the OCW for next UORA transmission. The non-AP STAs which transmit in the RA-RUs assigned by the trigger frame may set their OCW to the OCW value carried in this subfield. The non-AP STA may set its next OFDMA backoff (OBO) counter in the range=0 to OCW. (2) Next OCW assignment for successful transmission: the AP may indicate a value which may be used by a non-AP STA to derive the OCW for a next UORA transmission if the transmission from the non-AP STA in one or more RA-RUs assigned by the trigger frame is successful (e.g., the non-AP STA receives positive acknowledgement). The non-AP STA may set its next OBO counter in the range=0 to OCW. (3) Next OCW assignment for unsuccessful transmission: the AP may indicate a value which may be used by a non-AP STA to derive the OCW for next UORA transmission if the transmission from the non-AP STA in one or more RA-RUs assigned by the trigger frame is unsuccessful (e.g., the non-AP STA does not receive positive acknowledgement). The non-AP STA may set its next OBO counter in the range=0 to OCW.

According to another embodiment using a Modified AIML-based UORA procedure, an AP may announce EOCWmin and EOCWmax for the entire BSS. Based on these values, a non-AP STA is able to derive OCWmin and OCWmax values. A non-AP STA may set its initial OCW=OCWmin. The non-AP STA may adjust its OCW value based on an AIML UORA Mode Indication transmitted by the AP.

Several AIML UORA modes may be predefined or predetermined. Example embodiments may use AIML UORA modes including:
AIML UORA mode 1: a STA may set OCW=OCWmin after a successful UORA transmission; and set OCW=min(OCW*2+1, OCWmax) after an unsuccessful UORA transmission.
AIML UORA mode 2: a STA may set OCW=OCW1 after a successful UORA transmission; and set OCW=OCW2 after an unsuccessful UORA transmission. OCW1 and OCW2 may be derived by OCWmin and OCWmax. For example, OCW1=OCWmin and OCW2=OCWmax.
AIML UORA mode 3: a STA may set OCW=OCWmin after a successful UORA transmission; and set OCW=min(OCW+OCWconstant, OCWmax) after an unsuccessful UORA transmission. For example, OCWconstant may predefined as be ‘8’ or ‘16’ or other value.
AIML UORA mode 4: a STA may set OCW=OCWmin after a successful UORA transmission; and set OCW=min(OCW*OCWmultiple+1, OCWmax) after an unsuccessful UORA transmission. For example, OCWmultiple may predefined/predetermined as be ‘1’ or ‘2’ or other value.

An example embodiment may include an AP announcing OCW value(s) in the AIML UORA Trigger frame for non-AP STAs, which select random access resource units (RA-RUs) to transmit to set the OCW for their next UORA transmission.

Embodiments for AIML-based CSI compression and sounding feedback Management Procedures generally may include methods for: (i) AP Initiated AIML-based CSI report duration; and (ii) non-AP STA Enabled/Disabled AIML CSI report duration, as described below.

AP Initiated AIML based CSI report duration: In one embodiment, the AP may define a common AIML based CSI reporting time slot, in which the AIML based CSI reporting scheme is allowed in all non-AP STAs supporting AIML based CSI reporting scheme. The STAs supporting AIML based CSI reporting scheme, which may include the AP and/or non-AP STAs, may use the other time slot designated to the No AIML-based CSI report duration to train or enhance the AIML model. Note that the AIML-based CSI reporting duration indicates the AIML-based CSI reporting scheme is allowed. The AP may decide if the AIML-based CSI reporting scheme is used in each reporting instance of the sounding procedure. For example, the AP may use the null data packet announcement (NDPA) frame or trigger frame to notify the STAs whether an AIML-based CSI reporting scheme is requested or not.

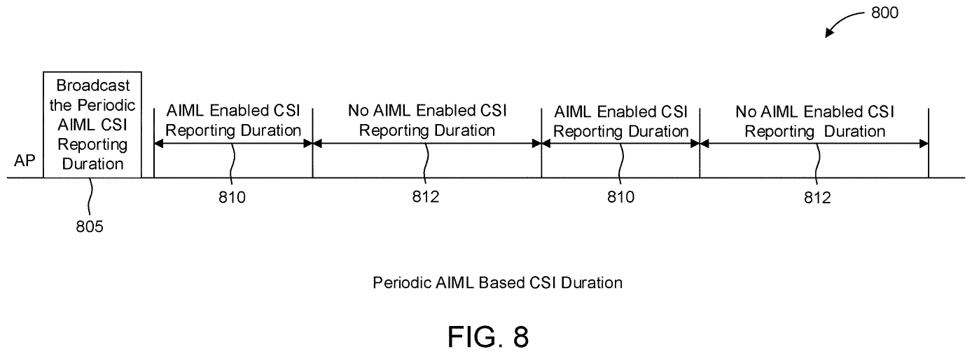

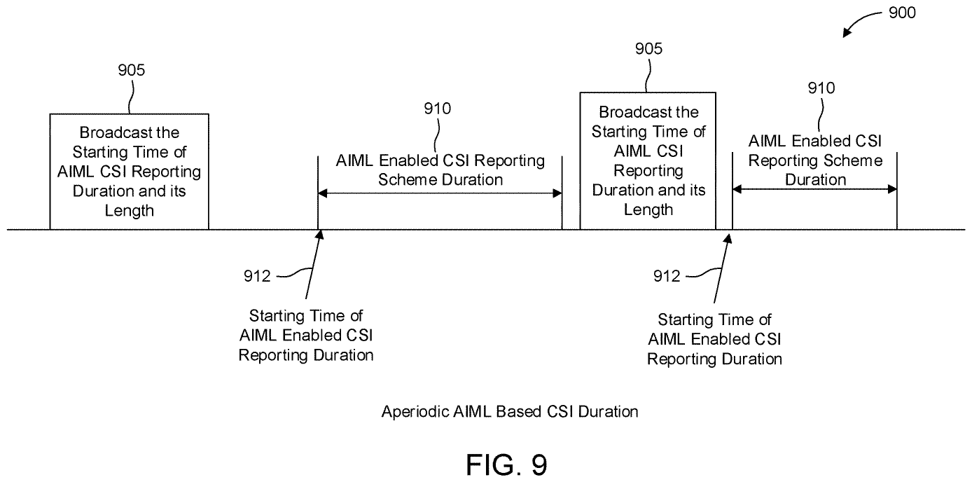

Referring to FIGS. 8-9, there may be multiple options to define the AIML-based CSI reporting time slot for STAs, examples of which include Periodic AIML-based reporting duration (FIG. 8) and Aperiodic AIML-based CSI reporting duration (FIG. 9).

In FIG. 8, an example timing chart 800 is shown in which the AIML-based CSI duration 805 may periodically appear. In this example embodiment, the length of the AIML-based CSI duration(s) 810 is fixed. The periodic AIML-based CSI reporting duration 805 may be included in a frame which is broadcast to all STAs. This information may be broadcast via the beacon frame or a management frame and the starting time of the Periodic AIML-based CSI Reporting Duration 805 and its duration may be included in the broadcast message. If the starting time is not included in the broadcast message 805, then the AIML-based CSI Reporting Duration(s) 810 may be started at a fixed time duration (t) after the broadcast message. This fixed time t may be a predefined system parameter and/or modified dynamically if desired. As shown in FIG. 8, there may also be a time duration(s) 812, referred to as “No AIML based CSI Reporting Duration.” During this time period 812, AIML-based CSI reporting schemes are not allowed. Alternatively, the AP may use this time period to perform event triggered AIML-based CSI report or individual AIML-based CSI reporting, which may be applied to one STA, a group of STAs or all STAs. The triggering message can be included in the NDP Announcement frame or Trigger frame.

In FIG. 9, a method 900 for Aperiodic AIML-based CSI reporting duration is shown in which the AP enables the AIML-based CSI duration aperiodically. In this example embodiment, the AIML-based CSI reporting duration 910 appears in a specific time 912, which may be indicated, for example, by the AP signaling 905 in the beacon frame or a management frame. In this embodiment, the duration may not be the same each time.

A beacon frame may be used to carry the AIML CSI reporting duration indication 905. Table 7 below shows an exemplary format for a beacon frame body with an AIML Reporting Duration Element included. Note that in the Order column of Table 3, N could be any number equal to or larger than ‘6.’

TABLE 7
Beacon frame body with AIML CSI Reporting Duration Element

| Order | Information | Notes |
|---|---|---|
| Last assigned + N | AIML CSI Reporting Duration | AIML CSI Reporting Duration Element is |
| | | present only when the AP and/or non- |
| | | AP STAs support AIML based CSI |
| | | reporting schemes |

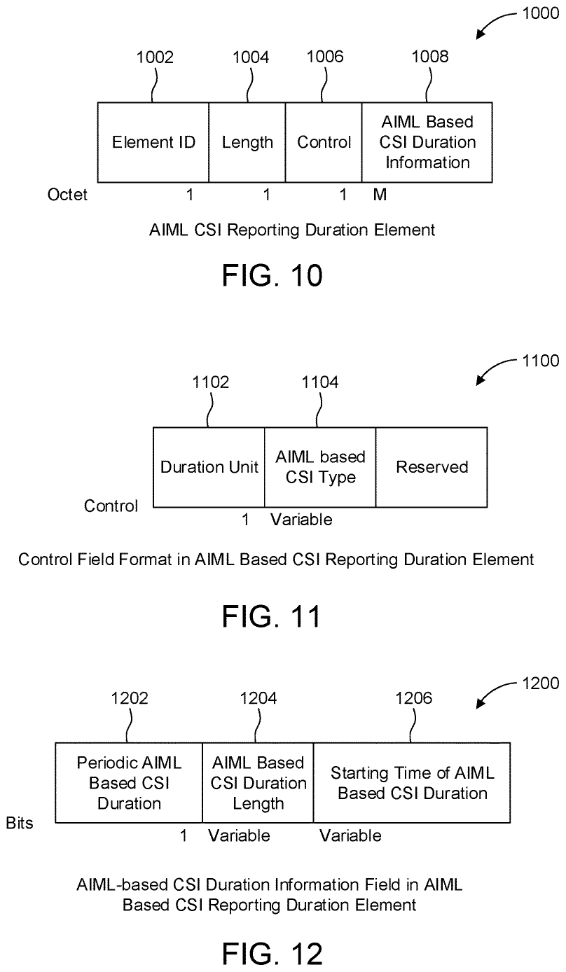

FIG. 10 illustrates an exemplary AIML CSI Reporting Duration element 1000 format according to one embodiment and may include: an Element ID field 1002, a Length field 1004, a Control field 1006 and an AIML-based CSI Duration Information field 1008. FIG. 11 depicts an exemplary Control field 1100 format in AIML CSI Reporting Duration element (e.g., element 1000 of FIG. 10). In one embodiment of Control field 1100 in FIG. 11, a Duration Unit subfield 1102 may indicate the unit of the AIML-based CSI Duration Length subfield and Starting Time of AIML-based CSI Duration subfield in AIML-based CSI Duration Information field (e.g., 1008 of FIG. 10). Duration unit subfield 1102 may be used for any other time unit related to AIML-based CSI duration. The exemplary number of bits for Duration unit subfield 1102 is 1-bit. For example, Duration unit subfield 1102 is set to ‘0’ if the unit is 256 μs and is set to ‘1’ if the unit is a Time Unit (TU). AIML based CSI Type subfield 1104 of FIG. 11, may determine that the interpretation of the subfields which are shown in AIML CSI Duration field, e.g., Starting Time of AIML based CSI Duration subfield and AIML based CSI Duration Length subfield. For example, value ‘0’ may indicate the common periods of AIML based CSI report duration for all STAs that support AIML based CSI reports; value ‘1’ may indicate the periods of AIML based CSI report duration for a group of STAs or a STA, etc.

FIG. 12 depicts an example format for an AIML-based CSI Duration Information field 1200 (e.g., format of field 1008 of FIG. 10). Periodic AIML-based CSI Duration subfield 1202 in FIG. 12 indicates if the AIML-based CSI Duration is periodic or not, e.g., ‘1’ represents the AIML based CSI Duration appears periodically and ‘0’ represents the AIML-based CSI Duration appears aperiodically. AIML-based CSI Duration Length subfield 1204 of FIG. 12 may indicate the length of AIML-based CSI Duration. Starting Time of AIML-based CSI Duration subfield 1206 in FIG. 12 may indicate the time when AIML-based CSI Duration starts, and may be delta time (e.g., relative time with respect to the end of beacon frame) or actual starting time. For example, the value in the Starting Time of AIML based CSI Duration subfield 1206 of FIG. 12 may be an integer value n, which may mean the AIML-based CSI Reporting Duration starts at an integer multiple (n+1) Time Units (TUs) (i.e., Starting Time of AIML-based CSI Reporting Duration mod (n+1)=0). Note that the fields in AIML-based CSI Reporting Duration element 1000 of FIG. 10 may be carried in any other MAC frames.

In one embodiment, the AIML-based CSI Duration notification may be grouped-based, which may give different groups of STAs different time slots to train/enhance their AIML model and make the power consumptions in different STAs evenly distributed. In other words, the STAs may not need to train/enhance AIML model (or have AIML-based CSI report duration) simultaneously. This option may enable STAs to avoid consuming the large amount power due to AIML model training/enhancement in the same time. For example, the AP may divide STAs into multiple groups. During Period-1, the AIML-based CSI reporting is enabled in Group-1 while no AIML-based CSI reporting is allowed in other groups. During Period-2, the AIML-based CSI reporting is enabled in Group-2 while no AIML-based CSI reporting is allowed in other groups, so on.

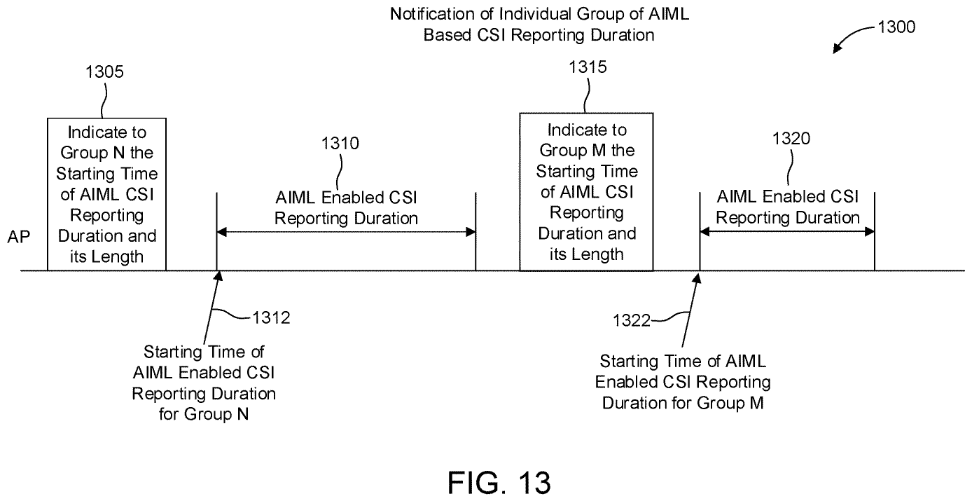

FIG. 13 depicts a timing chart of a method 1300 including an example notification of individual groups of AIML-based CSI reporting duration. In this example method 1300, the AP first sends one frame 1305 to STAs which belong to Group N and indicates the starting time 1312 of AIML CSI reporting duration 1310 and the corresponding length. During this duration 1310, AIML-based CSI reporting schemes are allowed for Group N STAs. Subsequently, the AP may send another frame 1315 to Group M STAs and indicates the starting time 1322 of AIML CSI reporting duration 1320 and the corresponding length. During this duration 1320, AIML-based CSI reporting schemes are allowed for Group M STAs. Note that the AIML-based CSI Reporting Durations 1310 and 1320 for different groups may be overlapping in certain embodiments.

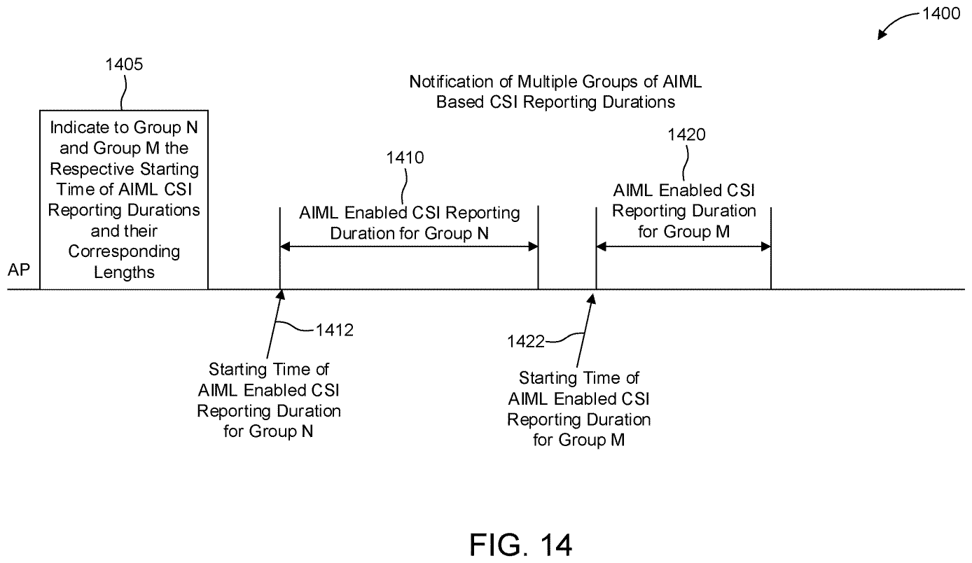

FIG. 14 is a timing chart depicting the exemplary notification method 1400 for multiple groups of AIML-based CSI reporting durations. In this example, the AP notifies multiple groups of STAs the respective AIML-based CSI reporting durations 1410, 1420 and corresponding duration lengths. In a preferred embodiment, the AP may use one management frame 1405 to carry this information and respective starting times 1412, 1422 of AIML-based CSI. CSI reporting durations 1410, 1420 may be indicated by group assignment, e.g., N vs. M, for a given STA.

If Group-based AIML-based CSI Reporting Duration is enabled, the AP may need to indicate to each STA which group of AIML-based CSI Reporting Duration to which the STA is assigned. This information may be carried in the beacon frame or any other management frames.

When the STA that supports AIML CSI reporting schemes is associated with the AP, related information may need to be indicated to the STA from the AP. As an example, the information can be carried in one element which may be included in the Probe Response frame or any other MAC frame.

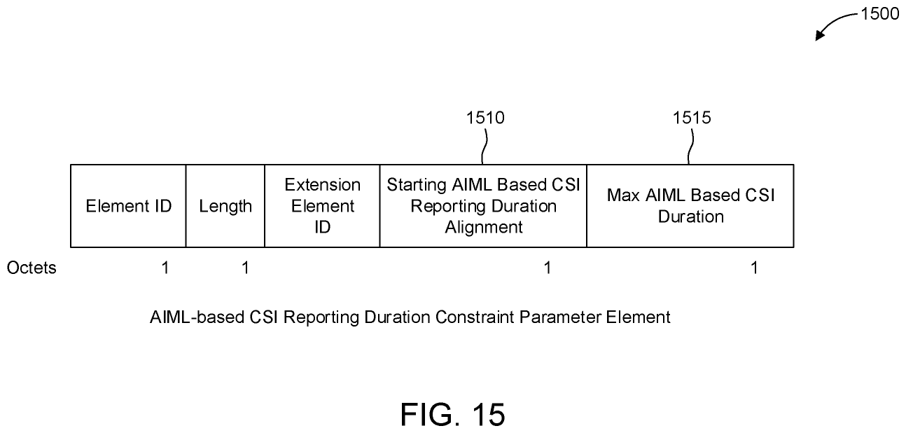

FIG. 15 depicts an exemplary AIML-based CSI Reporting Duration Constraints Parameter element 1500 according to one embodiment. The Starting AIML-based CSI Reporting Duration Alignment field 1510 may contain a positive integer n that indicates a recommended time for the start of the first AIML-based CSI reporting duration for this STA. A value of n may indicate that the first start time is recommended to be an integer multiple of n+1 TUs (i.e., (Target AIML based CSI Reporting Starting Time) mod (n+1)=0). The Max AIML-based CSI Duration field 1515 of FIG. 15 may contain the maximum allowed AIML-based CSI Duration.

In a second embodiment of AIML-based CSI compression and sounding feedback Management Procedures, a non-AP STA Enabled/Disabled AIML CSI report duration method may be utilized. In one embodiment, a STA that supports AIML-based CSI reports may indicate to the AP a capability change, e.g., low in power, to request the AP that the AIML-based CSI report may be disabled for a period of time. Upon reception of such a request, the AP may send the response to the requesting STA to disable the AIML-based CSI report, i.e., no AIML-based CSI report is allowed during a time period. In this embodiment, a No AIML-based CSI report duration may be included in the AIML-based CSI Report Duration response.

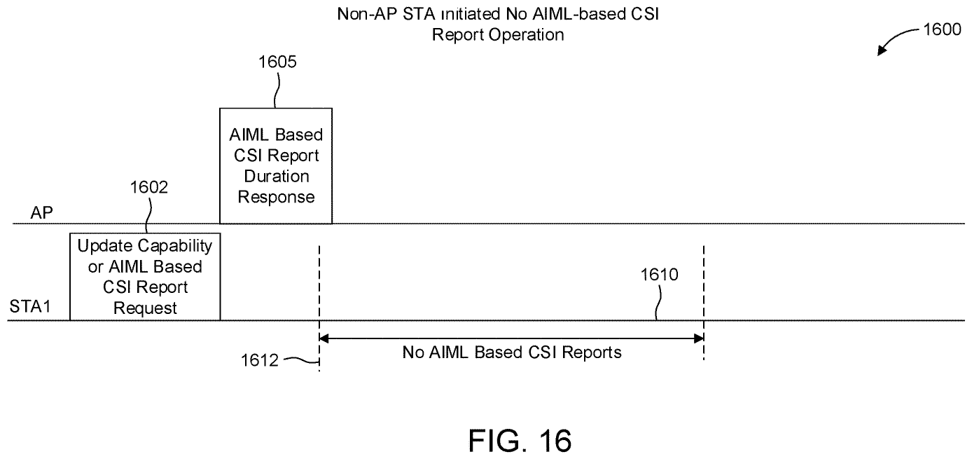

FIG. 16 is a message sequence chart depicting an example method 1600 for a non-AP STA initiated No AIML-based CSI report operation. In this example, STA1 sends an AIML-based CSI Report Request to the AP. This request may include the updated STA capability 1602, which is related to an AIML-based CSI report, e.g. available electric power change. Upon reception of this request, the AP may send the AIML-based CSI report Response 1605 to STA1 and indicate the starting time 1612 of the No AIML-based CSI reports or/and the length of No AIML-based CSI report duration 1610.

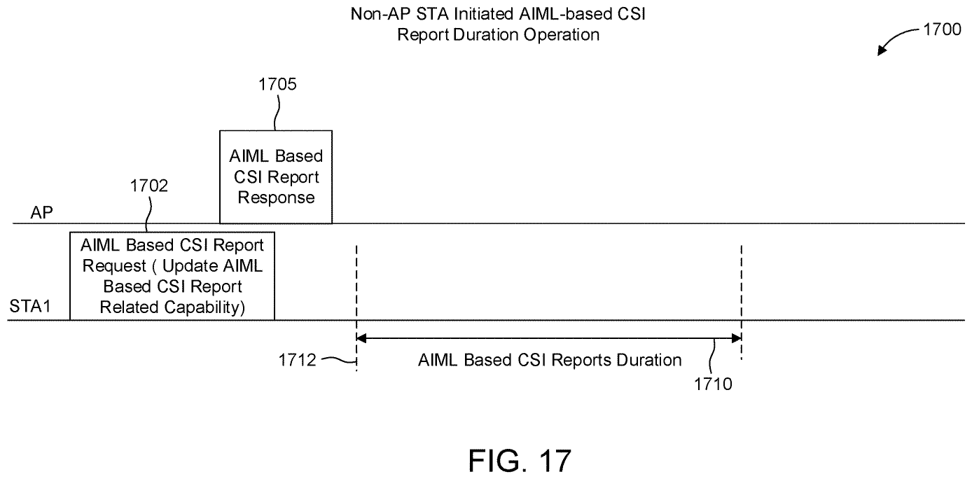

Similarly, as shown in reference to FIG. 17, which depicts an example method 1700 of a non-AP STA initiated AIML-based CSR Report Duration operation, a non-AP STA may also send the AIML-based CSI Report Request 1702 to the AP to request an assignment of AIML-based CSI reports duration 1710. Upon reception of such a request 1702, the AP may accept, reject or recommend the assignment of AIML-based CSI Report in the AIML-based CSI Report Response 1705. In the example of FIG. 15, the AP accepts the request 1702 from the STA and assigns the AIML-based CSI Report Duration 1710 to the requesting STA. Alternatively, the AP may reject the request from the STA, i.e., does not allow STA to send any AIML-based CSI reports, or recommend a starting time for this STA to perform AIML-based CSI reports. In this regard, a recommended starting time 1712, which may be included in the response frame, may not mean the STA can perform AIML-based CSI report. It may rather, indicate the STA should send the request again at the designated time. If the AP accepts the request 1702 from the STA or recommends the STA to start AIML-based CSI report at another time, it may need to include the following information in the response frame: (1) the starting time, e.g. 1712, of AIML-based CSI Report Duration; (2) The length of the AIML-based CSI Report Duration, e.g., duration 1710; (3) The group (e.g., group ID) that the requesting STA belongs to if it is a group-based AIML-based CSI Report Duration and other group-related parameters; (4) Suggested parameters that may be different from the parameters sent from the requesting STA; and/or (5) Suggested time for another request of AIML-enabled CSI report. In addition, the following information may also be included in the AIML-based CSI report request frame 1702 sent from the requesting STA: the maximum or minimum duration of AIML-based CSI report, the staring time of AIML-based CSI report, processing capability of AIML-based CSI report, etc.

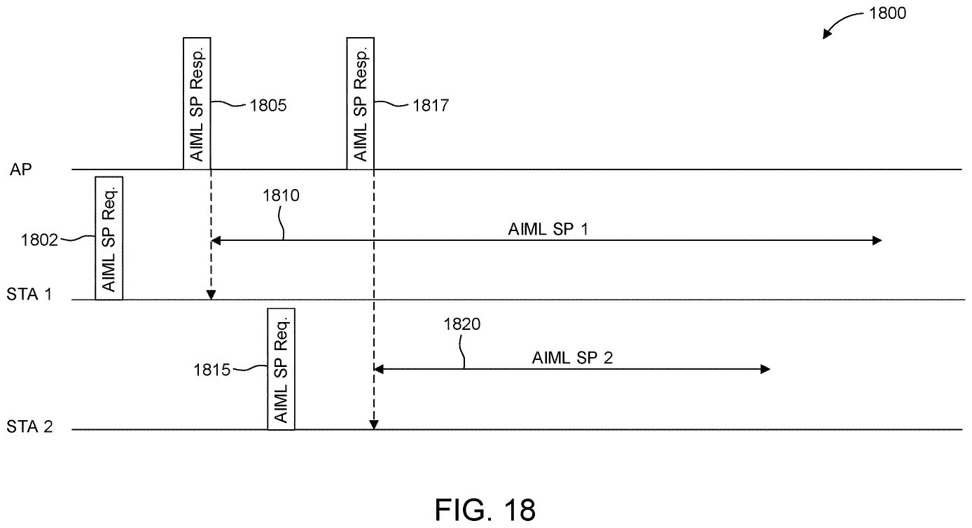

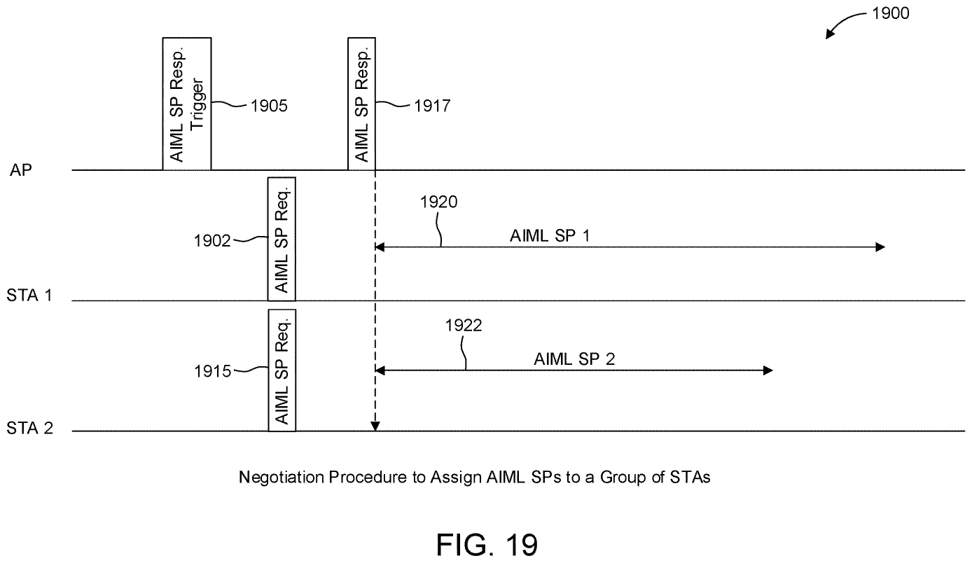

Referring to FIGS. 18 and 19, example embodiments of methods for AIML Service Periods Procedures will be described. In one embodiment, a STA that supports the AIML capability may negotiate with the AP when the AIML capability will be activated such that AIML-capable STAs can use this feature during those designated periods which are referred to as AIML Service Periods (SPs).

In one embodiment, the AIML-capable STAs may be allowed to perform one or more of the AIML elementary operations such as Dataset Generation, Dataset Transmission, Training, Inference, Model Transfer, and Model Parameters Tuning or one or more of the AIML-based services such as AIML-based channel access, AIML-based beam forming, AIML-based resource allocation, etc., only during the allowed AIML SPs.

According to one embodiment, the AIML-capable STAs may be active during the time, which is not designated as an AIML SP, but they are not allowed to use their AIML capabilities during this time. In this time, the AIML-capable devices may still use the other features they support to perform management, communication, or sensing operations.

In various embodiments, the AP may negotiate the AIML SPs with the AIML-capable STAs individually (e.g., method 1800 of FIG. 18) or negotiate the AIML SPs with a group of STAs (e.g., method 1900 of FIG. 19). In the individual AIML SP agreements, each STA may negotiate its assigned AIML SPs via a frame exchange sequence. Alternatively, in addition, or in group assigned AIML SPs, the beacon frame or any other management frame may be used to announce the AIML SPs in which a STA or a group of STAs are allowed to activate the AIML operation capability.

As one example of AIML SP management, the AP may schedule the AIML SPs such that it can balance the computational loads associated with operating in the AIML mode over a period of time. In this manner, the AP may avoid receiving too many requests for AIML elementary operations at a given time, which may negatively impact the overall system performance for users. On the other hand, the AP may use the concept of AIML SPs to guarantee a system-wide fairness for the legacy devices which do not support the AIML capability. By allocating some periods where AIML operation is disallowed, the legacy devices may have a better chance for the channel access and other services offered in the BSS.

In one embodiment, AIML-capable STAs may activate or deactivate some or all the AIML feature capabilities by sending operation management frames to the AP. If an AIML-capable STA deactivated the AIML operation, the AP may not consider this STA in any ongoing or upcoming AIML SPs negotiation until this STA (re)activates the AIML operation.

In one embodiment, as illustrated in FIG. 18 method 1800, STA1 may send an AIML SP Request frame 1802 to the AP in which the suggested parameters of the requested AIML SP are indicated by STA1. The AP may respond, after a short interframe space (SIFS) or any other Inter-Frame Spacing time, with an AIML SP Response 1805 frame to assign the AIML SP1 1810 to STA 1. STA 2 may send a different AIML SP Request frame 1815 and the AP may then respond with another AIML SP Response frame 1817 to assign AIML SP2 1820 to STA 2.

In an embodiment illustrated in FIG. 19 method 1900, an AP may initiate the AIML SP negotiation with a group of STAs at once by using an AIML SP Request Trigger frame 1905, by which the AP solicits the AIML SP Request frame(s) 1902, 1915 from multiple STAs at once. The AP may respond with AIML SP Response frame 1917 to assign the same AIML SP 1920, 1922 or different AIML SPs to different STAs at the same time. Various modification and combinations of requests and responses may be used to efficiently provide an AIML SP to AIML-enabled STAs.

AIML-capable STAs may indicate their support for receiving AIML broadcast announcements for the AIML service periods in the BSS in which those STAs may use their AIML capabilities to perform either AIML elementary operations or AIML-based services. The AP may use the Beacon frame or any other management frame to announce the AIML SPs in the BSS.

In further embodiments, Management Procedures for Coordinated and AIML-Based Operations for MLDs and MMLDs solutions are described to address one or more issues discussed previously.

As used herein, a multi-link device (MLD) may be defined as a logical entity that is capable of supporting more than one affiliated station (STA) and can operate using one or more affiliated STAs, and that presents one medium access control (MAC) data service and a single MAC service access point (SAP) to the logical link control (LLC) sublayer.

An AP MLD is an MLD where each STA affiliated with the MLD is an AP. A non-AP MLD is an MLD where each STA affiliated with the MLD is a non-AP STA. A Mixed MLD (MXMD) is an MLD where one or more STAs affiliated with the MLD is an AP and one or more STAs affiliated with the MLD is a non-AP MLD.

A multiple or Multi-Multi-Link-Device (MMLD) may include multiple APs, or STAs. Each of the APs or STAs that may be part of a physical device, which may be a Multi-link Device (MLD) which may consist of one or more APs or STAs. Each of the MLDs may be located in the same physical location or different physical location. A distributed AP MLD (DMLD) may be an MLD that consists of APs that are located at different locations. A mixed mode Multi-MLD (MMLD) may be an MLD that consists of one or more APs. Some of these APs may be a part of an MLD, while other of these APs may be such that it is not affiliated with a MLD other than the MMLD.

An AP Multi-MLD is an MMLD of which the STAs affiliated with the MMLD may be APs. A non-AP Multi-MLD is an MMLD of which the STAs affiliated with the MMLD may be non-AP STAs. A mixed STA Multi-MLD is an MMLD of which some of the STAs affiliated with the MMLD may be APs while some of the STAs affiliated with the MMLD may be non-AP STAs.

In accordance with certain embodiments, Information Request and Response Procedures for MLDs and MMLDs may be provided for a case where an AP that is affiliated with a DMLD or MLD may request information from its affiliated MLD or DMLD regarding channel usage, load information, etc., in order to conduct resource optimization, such as AIML-based resource allocation algorithms, or other type of resource allocation algorithms, etc.

An AP MLD that is affiliated with an MMLD or DMLD may request information from its affiliated MMLD regarding channel usage, load information, etc., in order to conduct resource optimization, such as AIML-based resource allocation algorithms, or other type of resource allocation algorithms, etc.

In one example, an AP that is affiliated with a DMLD or MLD may send a Resource Usage Information Request frame to its affiliated MLD or DMLD requesting information from/on one or more APs that are affiliated with the same DMLD or MLD. In one example, the AP may request resource usage information of just one set of APs affiliated with the DMLD or MLD, such as directly neighboring APs for the requesting AP, or a set of APs that may be identified in the frame by IDs such as MAC IDs or BSS colors, or MLD Colors. For certain embodiments, Resource Usage information requested may include, among others: Operating links; Operating channels for each links; Channel load for each operating channel; and/or Non-overlapping SPs on each operating channel, e.g., target wake times (TWTs), restricted (rTWTs), or basic (bTWTs), etc.

The DMLD or MLD may provide such information to the requesting AP in one or more Resource Usage Information Response frames carrying information requested for each requested AP or MLD or all APs or MLDs affiliated with the DMLD or MLD.

In another example, an MLD that is affiliated with an MMLD may send a Resource Usage Information Request frame to its affiliated MMLD, requesting information from one or more APs or MLDs that are affiliated with the same MMLD. In one example embodiment, the MLD may request resource usage information of just one set of APs or MLDs affiliated with the MMLD, such as directly neighboring MLDs for the requesting MLD, or a set of APs or MLDs that may be identified in the frame, by IDs such as MAC IDs or BSS colors, or MLD Colors or MLD MAC Address. For certain example embodiments, Resource Usage information requested may include, among others: Operating links of the MLD; Operating channels for each link(s); Channel load for each operating channels; and/or Non-overlapping SPs on each operating channel, e.g., TWTs or rTWTs, or bTWTs, etc. The MMLD may provide such information to the requesting MLD in, for example, one or more Resource Usage Information Response frames carrying information requested for each requested MLD or all MLDs affiliated with the MMLD.

Further embodiments for Coordinated and AIML-based Operation Management Procedures for MLDs and MMLDs are described. In order to manage the AIML-based operation, a DMLD or MLD may transmit, for example, an AIML Management Request frame to one or more of its affiliated APs or MLDs. The AIML Management Request frame in certain embodiments, may include one or more of the following information:
(1) AIML Operating Status: enabled, disabled (e.g., whether an AP or MLD is allowed to enable or needs to disable AIML-based operations);
(2) Allowed AIML Operations: (e.g., whether an AP or MLD is allowed to use AIML-based resource optimization, time allocation optimization, TWT allocation optimization, channel usage optimization, etc.);
(3) Allowed AIML Models: (e.g., whether the AP or MLD is only allowed to use DMLD or MLD distributed AIML models, or is allowed to use device-based AIML models); and/or
(4) Restrictions: (e.g., channel restrictions, time restrictions, TWT scheduling restrictions).

Example channel restrictions may include, e.g., if/when AIML-based, channel optimization is allowed at the AP or MLD, or restrictions pertaining to the channel width or number of channels that the AP or MLD are allowed to use on a particular link.

Example time restrictions may include, if/when, e.g., AIML-based, time optimization is allowed at the AP or MLD, the total amount or percentage of reserved channel time is allowed by the AP or MLD on a particular channel for a particular link. Example TWT scheduling restrictions may be related to if/when, e.g., AIML-based, TWT scheduling optimization is allowed at the AP or MLD, the total amount or percentage of reserved channel time is allowed by the AP or MLD for one particular, or a variety of different, TWTs on a particular channel for a particular link.

When an AIML Management Request frame is received by an AP or MLD from its affiliated DMLD or MLD, the receiving entity may transmit an ACK to the DMLD or MLD to indicate that it has received the frame. In some embodiments, the receiving entity may transmit an AIML Management Response frame to indicate the details of status or restrictions utilized locally for AIML-based operations. Example details of status may include AIML Operation mode, AIML Operations used, AIML Models used and restrictions used. The receiving entity may conduct allowed AIML-based operations according to the parameters and information indicated in the AIML Management Request frame.

In another example embodiment, in order to manage AIML-based operation, an MMLD may transmit an AIML Management Request frame to one or more of its affiliated APs or MLDs. The AIML Management Request frame, in certain embodiments, may include one or more of the following information:
(1) AIML Operating Status: enabled, disabled (e.g., whether the AP or MLD is allowed to enable or needs to disable AIML-based operations);
(2) Allowed AIML Operations: (e.g., whether the AP or MLD is allowed to use AIML-based resource optimization, time allocation optimization, TWT allocation optimization, channel usage optimization, etc.);
(3) Allowed AIML Models: (e.g., whether the AP or MLD is only allowed to use MMLD distributed AIML models, or is allowed to use device-based AIML models); and/or
(4) Restrictions: (e.g., one or more Channel restrictions, Time restrictions, and/or TWT scheduling restrictions).

Example Channel restrictions may include, when, e.g., AIML-based, channel optimization is allowed at the AP or MLD, the channel width or number of channels that the AP or MLD is allowed to use on a particular link. Example Time restrictions may include when, e.g., AIML-based time optimization is allowed at the AP or MLD, the total amount or percentage of reserved channel time is allowed by the AP or MLD on a particular channel for a particular link. Example TWT scheduling restrictions may include, for example, when AIML-based TWT scheduling optimization is allowed at the AP or MLD, the total amount or percentage of reserved channel time is allowed by the AP or MLD for one type, or a variety of, TWTs on a particular channel for a particular link.

When such an AIML Management Request frame is received by an AP or MLD from its affiliated MMLD, the AP/MLD may transmit an ACK to the MMLD to indicate that it has received the frame. In some embodiments, the receiving entity may transmit an AIML Management Response frame to indicate the details of status or restrictions being utilized locally for AIML-based operations, including AIML Operation mode, AIML Operations used, AIML Models used and/or restrictions used. The managed entity may conduct allowed AIML-based operations according to the parameters and information indicated in the AIML Management Request frame.

Although the features and elements of the present invention may be described in the example embodiments in particular combinations, each feature or element can be used alone without the other features and elements of the preferred embodiments or in various combinations with or without other features and elements of the present invention. Although the solutions described herein consider 802.11 specific protocols, it is understood that the solutions described are not restricted thereto and are applicable to other wireless systems where similarly suitable advantages may be obtained. While SIFS is used to indicate various inter frame spacing in the examples of the designs and procedures, all other inter frame spacing such as RIFS, AIFS, DIFS or other agreed time interval could be applied in the same solutions. Furthermore, while certain embodiments are described in terms of elements, fields and/or subfields, these terms are provided for a hierarchical relation to assist in understanding and may be used interchangeably without departing from the disclosed embodiments.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for a wireless station (STA), the method comprising:
receiving a notification that an access point (AP) supports artificial intelligence machine learning (AIML)-based procedures in a wireless network;
sending AIML capabilities of the STA to the AP;
receiving AIML instructions from the AP; and
accessing a channel in the wireless network using AIML procedures based on the received AIML instructions.

2. The method of claim 1, wherein the received AIML instructions comprise an AIML-based operation management procedure for one or more of channel access, channel state information (CSI) feedback, uplink orthogonal frequency division multiple access (OFDMA) random access (UORA) or a service period (SP) specifying a duration when the STA may use AIML-based operation management procedures.

3. The method of claim 1, wherein the received AIML instructions comprise one or more fields of an AIML element identifying a AP distributed AIML model or an AIML model of the STA to be used in accessing the channel.

4. The method of claim 3, wherein the AIML element identifies the AP distributed AIML model as an only allowed AIML model.

5. The method of claim 1, further comprising:
receiving, from the AP, an AIML operation mode change frame to disable one or more AIML-based operation management procedures used by the STA.

6. The method of claim 1, wherein the notification that the AP supports AIML-based procedures is received by the STA in an AIML announcement frame or an AIML beacon.

7. The method of claim 2, wherein the AIML-based operation management procedure is for CSI feedback and includes an AIML CSI reporting duration defining when the STA may use AIML-based CSI feedback reporting.

8. A station (STA) comprising:
a processor and a transceiver in communication with the processor, wherein the processor and transceiver are configured to:
receive a notification that an access point (AP) supports artificial intelligence machine learning (AIML)-based procedures in a wireless network;
send AIML capabilities of the STA to the AP;
receive AIML instructions from the AP; and
access a channel in the wireless network using AIML procedures based on the received AIML instructions.

9. The STA of claim 8, wherein the received AIML instructions comprise an AIML-based operation management procedure for one or more of channel access, channel state information (CSI) feedback, uplink orthogonal frequency division multiple access (OFDMA) random access (UORA) or a service period (SP) specifying a duration when the STA may use AIML-based operation management procedures.

10. The STA of claim 8, wherein the received AIML instructions comprise one or more fields of an AIML element identifying an AP distributed AIML model or a STA AIML model to be used in accessing the channel.

11. The STA of claim 10, wherein the AIML element identifies the AP distributed AIML model as an only allowed AIML model.

12. The STA of claim 8, wherein the processor and transceiver are further configured to:
receive, from the AP, an AIML operation mode change frame to disable one or more AIML-based operation management procedures used by the STA.

13. The STA of claim 8, wherein the notification that the AP supports AIML-based procedures is received by the STA in an AIML announcement frame or an AIML beacon.

14. The STA of claim 9, wherein the AIML-based operation management procedure is for CSI feedback and includes an AIML CSI reporting duration defining when the STA may use AIML-based CSI feedback reporting.

15. An access point (AP) comprising:
a processor and a transceiver in communication with the processor, wherein the processor and transceiver are configured to:
send, to one or more stations (STAs) a notification that the AP supports artificial intelligence machine learning (AIML)-based procedures in a wireless network;
receive AIML capabilities of a STA;
determine, based on the received capabilities of the STA, AIML instructions for the STA to use in accessing a channel in the wireless network; and
send the determined AIML instructions to the STA.

16. The AP of claim 15, wherein the sent AIML instructions comprise an AIML-based operation management procedure for one or more of channel access, channel state information (CSI) feedback, uplink orthogonal frequency division multiple access (OFDMA) random access (UORA) or a service period (SP) specifying a duration when the STA may use AIML-based operation management procedures.

17. The AP of claim 15, wherein the sent AIML instructions comprise one or more fields of an AIML element identifying an AP distributed AIML model or the STA's own AIML model to use in accessing the channel.

18. The AP of claim 15, wherein the processor and transceiver are further configured to:
send, to the STA, an AIML operation mode change frame to disable one or more AIML-based operation management procedures used by the STA.

19. The AP of claim 15, wherein the notification that the AP supports AIML-based procedures is sent to the STA in an AIML announcement frame or an AIML beacon.

20. The STA of claim 16, wherein the AIML-based operation management procedure is for CSI feedback and includes an AIML CSI reporting duration defining when the STA may use AIML-based CSI feedback reporting.
